(19) United States
(12) Patent Application Publication
(10) Pub. No.: US 2026/0020016 A1
(43) Pub. Date: Jan. 15, 2026

(54) TECHNIQUES FOR A LEARNING-BASED SCHEDULER

(71) Applicant: Lenovo (Singapore) Pte. Ltd., Singapore (SG)

(72) Inventors: Joachim Löhr, Wiesbaden (DE); Hossein Bagheri, Dearborn Heights, MI (US); Vahid Pourahmadi, München (DE)

(21) Appl. No.: 18/771,973

(22) Filed: Jul. 12, 2024

(51) Int. Cl. H04W 72/1268; H04W 24/10

(52) U.S. Cl. CPC H04W 72/1268; H04W 24/10

(57) ABSTRACT

Various aspects of the present disclosure relate to techniques for a learning-based scheduler. A user equipment is configured to receive a configuration for capturing uplink status information, the uplink status information comprising buffer status information, delay status information, or a combination thereof. The user equipment is configured to capture the uplink status information according to the configuration. The user equipment is configured to report the uplink status information to a learning-based scheduler.

### TECHNICAL FIELD

The present disclosure relates to wireless communications, and more specifically to techniques for a learning-based scheduler.

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE may be configured to or operable to support a means to receive a configuration for capturing uplink status information, the uplink status information comprising buffer status information, delay status information, or a combination thereof, capture the uplink status information according to the configuration, and report the uplink status information to a learning-based scheduler.

A network entity may be configured to support a means to transmit a configuration for capturing uplink status information at a UE, the uplink status information comprising buffer status information, delay status information, or a combination thereof. The network entity may be configured to support a means to receive the uplink status information from the UE and train a learning-based scheduler based on the uplink status information.

### BRIEF DESCRIPTION OF THE DRAWINGS

FIG. 1 illustrates an example of a wireless communications system in accordance with aspects of the present disclosure.

FIG. 2A depicts one embodiment of a model, in accordance with aspects of the present disclosure.

FIG. 2B depicts one embodiment of a model, in accordance with aspects of the present disclosure.

FIG. 3 depicts one embodiment of delay status information, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by a device in accordance with aspects of the present disclosure.

FIG. 8 illustrates a flowchart of a method performed by a device in accordance with aspects of the present disclosure.

### DETAILED DESCRIPTION

A wireless communication network supporting one or more radio access technologies, such as 5G, may support scheduling transmission/reception of data. A scheduler schedules user data transmissions/receptions per slot or a set of slots. Advanced schedulers can exploit machine learning (ML) and artificial intelligence (AI) techniques to determine time frequency resources, and/or to determine or predict other scheduling-related parameters associated with the scheduled transmissions/receptions, which could be useful for near-optimal scheduling according to any optimality criterion. The predicted parameters (e.g., remaining latency budget of a data unit or a power headroom) can be inaccurate due to prediction error, which could impact the performance of the scheduler.

To train an AI/ML model, e.g., for example for beam prediction, the AI/ML training entity collects L1 measurements for the AI/ML training. The collected training data samples are provided, e.g., offline, to the entity where the AI/ML model resides. For the specific use case of an AI/ML-based scheduler, uplink (UL) control information like buffer status information, delay status information and power status information may be used for the offline training of an AI/ML model. There are UE scheduling-related reporting procedures defined in 3GPP TS38.321 (incorporated herein by reference), e.g., buffer status reporting (BSR) procedure, delay status reporting (DSR) procedure and power headroom reporting (PHR) procedure. Those procedures define a framework where the UE reports some assistance information that is used by the network (NW) scheduler to assign time/frequency resources to users for UL transmissions.

However, those scheduling related reporting procedures are independent procedures, e.g., different reporting triggers and configurations (e.g., periodic reporting) are defined for the respective procedures. Therefore, the UE will not provide the BSR/DSR and PHR information together to the NW. Furthermore, the DSR procedure may provide only information about delay-critical data to the NW, e.g., DSR is triggered/reported when the remaining time of a PDU/PDU set becomes less than a configured threshold. Therefore, scheduling-related UL information reporting procedures like BSR/DSR and the PHR procedure are not well suited for the purpose of collecting/providing training data for an AI/ML-based scheduler.

The subject matter herein proposes solutions for the collection of training data for training of an AI/ML based scheduler. In the various embodiments described herein, a new type of UE assistance information e.g., referred to as UL status information, is defined, which serves as training data for an AI/ML based scheduler e.g., residing in the gNB. Furthermore, new reporting procedures for the UL status information are described.

Aspects of the present disclosure are described in the context of a wireless communications system.

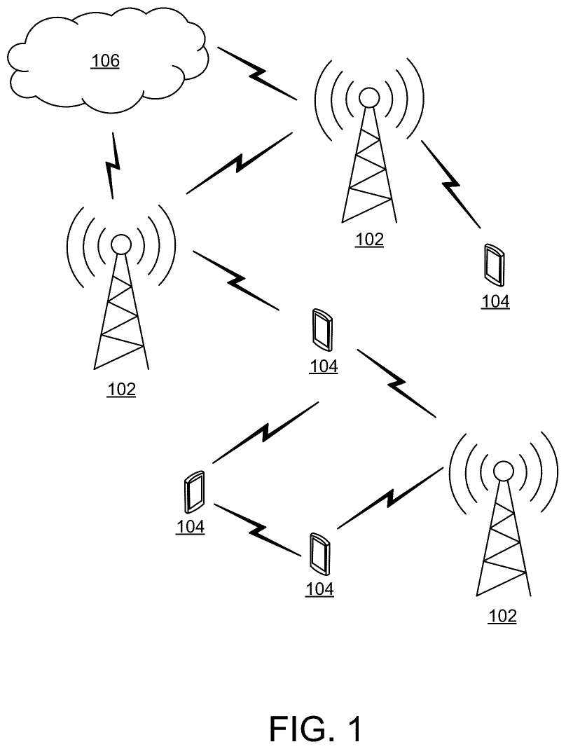

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (NB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmit-receive points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a UPF). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHz-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In conventional solutions, the specified UL scheduling related reporting procedures like BSR, DSR, and PHR procedures are used for the training of an AI/ML-base scheduler. However, since those procedures are configured and run independently in the UE, the information is not reported simultaneously, e.g., the gNB might have only buffer status information but not corresponding delay information. Furthermore, since the DSR procedure is only providing information on delay-critical data to the gNB, the scheduler (AI/ML-model) might not have the complete information/data for the training, which in turn decreases the efficiency of the performance of the model.

According to TS 38.321 (incorporated herein by reference), the BSR procedure is used to provide the serving gNB with information about UL data volume in the medium access control (MAC) entity. Each logical channel may be allocated to an LCG using the logicalChannelGroup.

The MAC entity determines the amount of UL data available for a logical channel according to the data volume calculation procedure in TSs 38.322 and 38.323 (incorporated herein by reference). A BSR shall be triggered if any of the following events occur for activated cell group:

UL data, for a logical channel, which belongs to a logical channel group (LCG), becomes available to the MAC entity and either the UL data belongs to a logical channel with higher priority than the priority of any logical channel containing available UL data which belong to any LCG or none of the logical channels that belong to an LCG contains any available UL data, in which case the BSR is referred below to as ‘Regular BSR’.

UL resources are allocated and number of padding bits is equal to or larger than the size of the BSR MAC control element (CE) plus its subheader, in which case the BSR is referred to as ‘Padding BSR’.

retxBSR-Timer expires, and at least one of the logical channels which belong to an LCG contains UL data, in which case the BSR is referred below to as ‘Regular BSR’.

periodicBSR-Timer expires, in which case the BSR is referred below to as ‘Periodic BSR’.

It is noted that when regular BSR triggering events occur for multiple logical channels simultaneously, each logical channel triggers one separate regular BSR. For regular and periodic BSR, the MAC entity for which logicalChannelGroupIAB-Ext is not configured by upper layers shall:
1> if for at least one LCG configured with additionalBSR-TableAllowed, the amount of UL data available for transmission is within the buffer sizes specified in Table 6.1.3.1-3:
2> report Refined Long BSR for all LCGs which have data available for transmission;
1> else:
2> if more than one LCG has data available for transmission when the MAC PDU containing the BSR is to be built:
3> report Long BSR for all LCGs which have data available for transmission.
2> else:
3> report Short BSR.

According to TS 38.321, the DSR procedure is used to provide the serving gNB with delay status of LCGs. This delay status for an LCG includes remaining time, which is the smallest remaining value of the packet data convergence protocol (PDCP) discardTimers among service data units (SDUs) buffered for the LCG as specified in clause 7.3 in TS 38.323 (incorporated herein by reference), and the total amount of delay-critical UL data for the LCG according to the data volume calculation procedure specified in clause 5.5 in TS 38.322 (incorporated herein by reference) and clause 5.6 in TS 38.323 (incorporated herein by reference) for the associated radio link control (RLC) and PDCP entities, respectively.

Radio resource control (RRC) controls the DSR procedure by configuring the parameter remainingTimeThreshold: the threshold on remaining time for triggering a DSR for an LCG.

If an LCG is configured for delay status reporting, the MAC entity shall:
1> if the smallest remaining value of the PDCP discardTimers among all the data buffered for the LCG that has not been transmitted in any MAC PDU or reported as data volume in a DSR MAC CE becomes below remaining Time Threshold of the LCG; and
1> if there is no DSR pending for the LCG since the last transmission of a DSR MAC CE:
2> trigger a DSR for the LCG.

If there is at least one DSR pending, the MAC entity shall:
1> if UL-SCH resources are available for a new transmission and the UL-SCH resources can accommodate the DSR MAC CE plus its subheader as a result of logical channel prioritization:
2> instruct the Multiplexing and Assembly procedure to generate the DSR MAC CE;
1> else if there is no pending SR already triggered by the DSR procedure for the same logical channel as of this DSR:
2> trigger a Scheduling Request.

An SDU is considered to be associated with a DSR if it is associated with the LCG which triggered the DSR and the remaining value of its PDCP discardTimer is below remaining Time Threshold.

MAC PDU shall contain at most one DSR MAC CE. The MAC entity shall not include a DSR MAC CE in a MAC PDU if the MAC PDU can accommodate the SDUs associated with all the pending DSRs. After a DSR is triggered, it is considered as pending until it is cancelled. The MAC entity shall cancel a pending DSR, either when all the SDUs associated with the DSR have been discarded, or when a MAC PDU is transmitted and this MAC PDU includes either all the SDUs associated with the DSR or a DSR MAC CE that contains the delay information of all the SDUs associated with the DSR (as described in the clause 6.1.3.72).

According to TS 38.321, the PHR reporting procedure is used to provide the serving gNB with Type 1 power headroom—the difference between the nominal UE maximum transmit power and the estimated power for UL-shared channel (SCH) transmission per activated serving cell.

A PHR may be triggered if any of the following events occur:

phr-ProhibitTimer expires or has expired and the path loss has changed more than phr-Tx-PowerFactorChange dB for at least one RS used as pathloss reference for one activated Serving Cell of any MAC entity of which the active DL bandwidth parth (BWP) is not dormant BWP since the last transmission of a PHR in this MAC entity when the MAC entity has UL resources for new transmission. It is noted that the path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331 (incorporated herein by reference).

phr-PeriodicTimer expires.

upon configuration or reconfiguration of the power headroom reporting functionality by upper layers, which is not used to disable the function.

activation of an SCell of any MAC entity with configured uplink of which firstActiveDownlinkBWP-Id is not set to dormant BWP.

activation of a second cell group (SCG).

addition of the PSCell except if the SCG is deactivated (i.e. PSCell is newly added or changed).

phr-ProhibitTimer expires or has expired, when the MAC entity has UL resources for new transmission, and the following is true for any of the activated Serving Cells of any MAC entity with configured uplink:

there are UL resources allocated for transmission or there is a PUCCH transmission on this cell, and the required power backoff due to power management (as allowed by P-MPRc as specified in TS 38.101-1 (incorporated herein by reference), TS 38.101-2 (incorporated herein by reference), and TS 38.101-3 (incorporated herein by reference)) for this cell has changed more than phr-Tx-PowerFactorChange dB since the last transmission of a PHR when the MAC entity had UL resources allocated for transmission or physical uplink control channel (PUCCH) transmission on this cell.

upon switching of activated BWP from dormant BWP to non-dormant DL BWP of an SCell of any MAC entity with configured uplink.

It is noted that the MAC entity should avoid triggering a PHR when the required power backoff due to power management decreases only temporarily (e.g. for up to a few tens of milliseconds) and it should avoid reflecting such temporary decrease in the values of PCMAX,f,c/PH when a PHR is triggered by other triggering conditions.

If the MAC entity has UL resources allocated for a new transmission the MAC entity shall:
1> if it is the first UL resource allocated for a new transmission since the last MAC reset:
2> start phr-PeriodicTimer.
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP as defined in clause 5.4.3.1:
2> if multiplePHR with value true is configured:
3> for each activated Serving Cell with configured uplink associated with any MAC entity of which the active DL BWP is not dormant BWP; and
3> for each activated Serving Cell with configured uplink associated with E-UTRA MAC entity:
4> else (i.e. this MAC entity is not configured with twoPHRMode):
5> if this Serving Cell is not configured with multiple TRP PUSCH repetition or the MAC entity this Serving Cell belongs to is not configured with twoPHRMode:
6> obtain the value of the Type 1 or Type 3 power headroom for the corresponding uplink carrier as specified in clause 7.7 of TS 38.213 (incorporated herein by reference) for NR Serving Cell and clause 5.1.1.2 of TS 36.213 (incorporated herein by reference) for E-UTRA Serving.

The subject matter herein focuses on a scenario where the model/inference is at the network side, e.g. a scheduler at the gNB; however, the model/inference/scheduler could be located on a UE or other network device. While this disclosure focuses on the scheduler containing an AI/ML model mainly, some of the teachings can be applicable to any network AI/ML model functionality. In one embodiment, the UE sends a BSR to the network, and the scheduler (e.g., based on AI/ML techniques) considering the BSR as an input to the scheduler, schedules the UE.

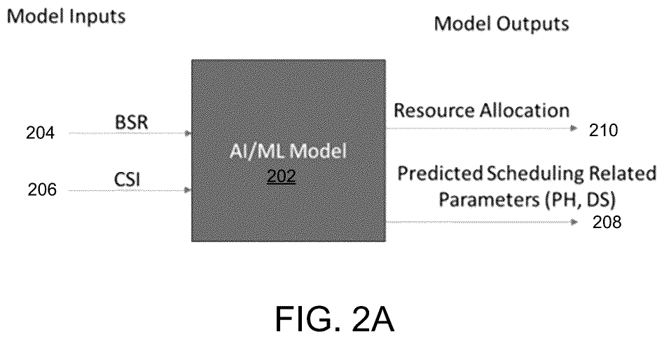

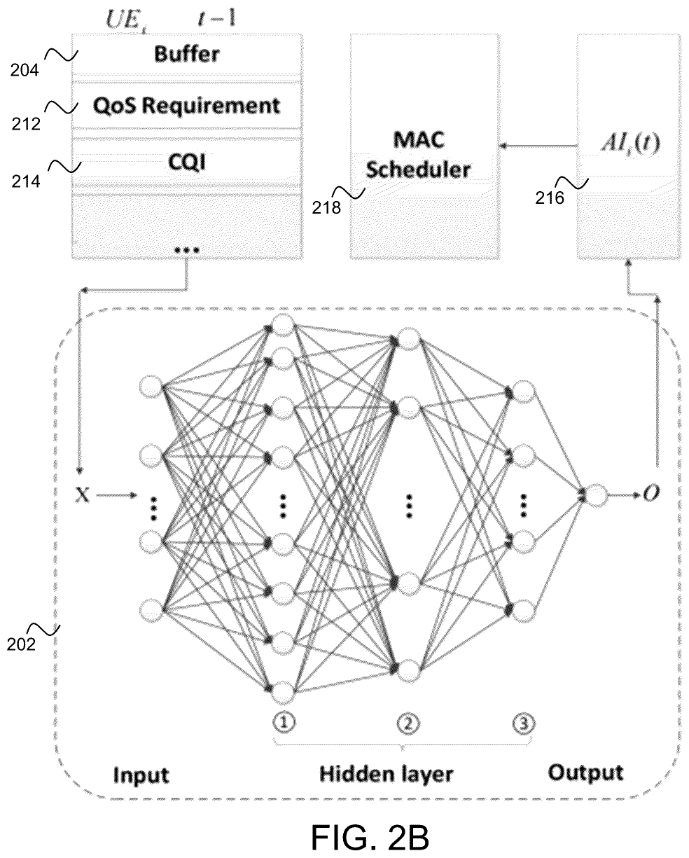

FIG. 2A depicts one embodiment of a model, in accordance with aspects of the present disclosure. In one embodiment, an AI/ML model 202 may, based on provided input parameters, e.g., BSR 204, channel state information (CSI) 206, quality of service (QOS) requirements, the scheduling decisions in the previous time slots, or the type of the logical channel, predict some scheduling related parameters 208 in the UE and use those parameters (model output) as an input to the scheduler, which in turn allocates UL resources to the UE(s).

FIG. 2B depicts one embodiment of a model, in accordance with aspects of the present disclosure. In the depicted embodiment, the model 202 is depicted as a neural network with a plurality of different layers. Inputs such as BSR 204, QoS requirements 212, channel quality indicator information 214, or the like are provided to the model 202 and the outputs 216 from the model are provided as input to the scheduler 218, e.g., a MAC scheduler.

In one embodiment, a new type of uplink information, which is also referred to as UL status information, is defined. According to one implementation of the embodiment, the new UL status information is used as data for different life cycle management (LCM) phases of an AI-based scheduler, e.g., residing in the gNB. In one example, the UL status information is collected by the UE and reported by the UE to the gNB for the purpose of training the AI/ML model, e.g., AI/ML based scheduler.

According to one implementation of the embodiment, the UL status information is comprised of buffer status information and delay status information, wherein the delay status information indicates in one example the delay status of the data indicated within the buffer information. In one example the delay status information is comprised of a remaining delay associated with a data unit, e.g., PDU(s)/SDU(s). According to one specific implementation of the embodiment, the remaining delay of a data unit, e.g., PDU/SDU, is determined based on the corresponding PDCP discardTimer value, e.g., value of the PDCP discardTimer of the corresponding PDCP SDU.

According to one implementation of the embodiment, the buffer status information is comprised of one or more data volume(s) each associated with an LCG. According to one specific implementation, the data volume corresponds to the total amount of data available for transmission for the LCG. In one example the buffer status information is comprised of a long BSR.

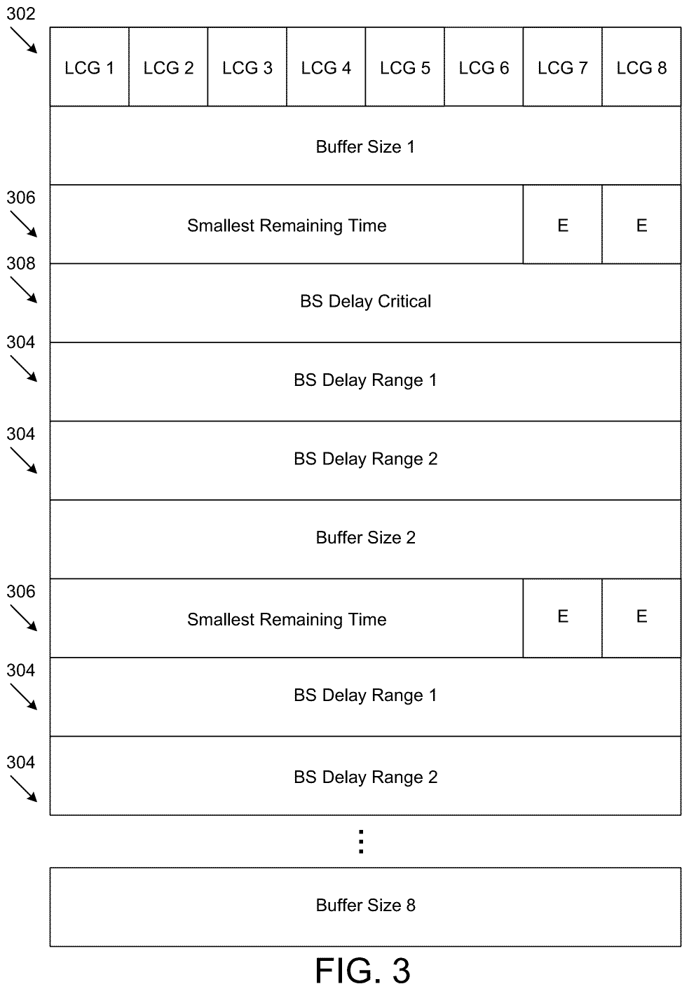

FIG. 3 depicts one embodiment of delay status information, in accordance with aspects of the present disclosure. According to one implementation of the embodiment, the delay status information is comprised of the smallest remaining time value 306 of the running PDCP discardTimers among SDUs that are buffered for the LCG 302. In one example, the delay status information is comprised of the smallest remaining time value 306 of the running PDCP discardTimers among SDUs that are buffered for the LCG but have not been transmitted in any MAC PDU.

According to one implementation of the embodiment, the delay status information is further comprised (in addition to the smallest remaining time delay information) of the total amount of delay-critical UL data 308 for the LCG 302 (as specified in TS38.323/TS38.322 (both incorporated herein by reference)). In one example the delay status information is comprised of information indicating the total amount of data for the LCG 302 for which the corresponding remaining delay is within a (pre) configured delay range 304. By including in the UL status information and the amount of data (of a LCG 302) for the different configured remaining delay ranges 304, an accurate representation of the (current) UE buffer situation is provided, which can be used for the purpose of training the AI-based scheduler.

According to one implementation of the embodiment, the NW configures whether the delay status information should be included for a LCG or LCH in the UL status information. In one embodiment, delay information might be needed for the training of the AI-based scheduler for specific LCGs or LCHs, e.g., an LCH containing XR services.

According to one implementation of the embodiment, the UL status information is comprised of data, e.g., also referred to as outdated data, for which the corresponding PDCP discardTimer is already expired. In one example, the outdated data refers to PDUs/SDUs that have been delivered to MAC for transmission, e.g., data is still available for transmission in the Layer 2 protocols (MAC/RLC) even though the corresponding PDCP discardTimer is already expired.

According to one implementation of the embodiment, the UL status information is comprised of UL power information. In one example, power headroom information is part of the UL status information (e.g., a reference format for PHR information for logging is used or alternatively the UE stores the transport block size (TBS)/UL grant information for which the power status was calculated). According to one implementation of the UE, a virtual PHR is included as part of the UL power information. In one example, pathloss information, e.g. pathloss between the UE and gNB, is included as part of the UL status information. The pathloss information may be obtained by reference signal measurements performed by the UE, e.g. Reference Signal Received Power (RSRP) measurement.

According to one implementation of the embodiment, the UL status information is comprised of previous UL grants/allocations processed by the UE, e.g., UL transmissions performed for the corresponding UL grants. In one example, the UL status information contains information on the previous UL grants/allocations executed by the UE, e.g., UL grants that resulted in an UL transmission (e.g., a PUSCH transmission). According to one implementation of the embodiment, the UL status is comprised of information for the UE's UL grants/allocation received/executed since the last reported/logged UL status information. Since UL grants, and in particular, the PUSCH transmissions according to the UL grants, impact the buffer/delay status of the UE, it is beneficial for the training of the AI/ML model (the AI/ML-based scheduler) to provide the information on the received UL grants. According to one example, the UL grant information is comprised of the Transport Block Size (TBS) indicated by the corresponding UL grant/resource allocation. Since the TBS is mostly affecting the UE's buffer/delay status, e.g., LCP procedure is invoked with the TBS as an input, it might be sufficient to just inform the allocated TBS instead of the complete UL grant information. In one example the UL status information also contains a time stamp for UL grant resources that have been allocated, e.g., when the corresponding PUSCH transmission has been performed or alternatively when the UL grant has been received. According to one example the time stamp may be associated with a BSR, DSR, PHR, or the like. The inclusion of the time stamp can be useful for the scheduler to process the UL status information of multiple users associated with the same/similar time stamp jointly.

According to one implementation of the embodiment, a time information, e.g., a time stamp, is part of the UL status information, e.g., the time information indicates the time when the UL status information was generated. According to one implementation of the embodiment, the UL status information is comprised of information regarding the new data that has been added to each of the LCH or LCG. This information can be beneficial for modeling the input data statistics which can be used for better training of the AI/ML model.

According to one implementation of the embodiment, the UL status information is comprised of Quality of Experience (QoE) information. As used herein, QoE information may refer to subjective acceptability of the quality of a telecommunication service perceived by the user. This information can be beneficial for “learning” the statistics regarding a scheduling decision and the corresponding quality experienced by a user, e.g., relationship between UL resource allocation and/or RAN performance and the quality of a service experienced by a user. In one example the QoE information is reported by LCH or LCG.

In one embodiment, a UE is configured with a configuration that instructs or commands the UE to store one or more samples of UL status information as described in the previous embodiment. According to one implementation of the embodiment, a new RRC configuration is introduced configuring the UE for logging UL status information, e.g. for the purpose of data collection for offline training of an AI/ML-based scheduler. In one implementation of the embodiment, one or more samples of UL status information, e.g., also referred to as logged UL status information, is reported in an L3 message, e.g., RRC message from the UE to the NW. In one example NW configures the UE for reporting of logged UL Status information. When NW provides the configuration related to the reporting of logged UL status information in a UL L3 message (e.g. SRB), additional association information is included in order to associate the logging configuration with the reporting configuration. An RRC reporting configuration for data collection, with relaxed latency requirements and lower priority, configured by the NW to UE is used to generate/send an L3 report containing multiple logged UL status information, wherein the logged UL status information may be performed by different logging configurations.

According to one implementation of the embodiment logging and reporting of UL status information are two steps performed by UE which can be triggered according to different conditions. The conditions may be in one example configured by the NW (gNB).

According to one implementation of the embodiment, the NW configures, as part of the RRC logging configuration, for which LCG(s)/LCH(s) UE shall store/log UL status information. In one example, the UE may stop the logging of UL status information when the radio bearer configuration of the UE changes, e.g., in the case of radio bearer removal/addition, or when a configured grant configuration is changed.

According to one example, logged UL status information that is reported to the NW (for the purpose of training) includes the layer 2 configuration parameter, e.g., DRB(s)/SRB(s) configured for the UE while logging the UL status information. In another example, the report of logged UL status information contains information on the LCH restriction configurations. Since the restrictions configured for the LCHs impacts the result of the LCP procedure, e.g., how allocated UL resources are distributed among the configured LCHs, it may be beneficial for the AI/ML-based scheduler to consider this information during the training phase. Furthermore, a report may include information on whether PDU Set Importance (PSI)-based discarding was enabled while logging the UL status information within the UE. According to one implementation of the embodiment, UE assistance information reporting is used by the UE to provide logged or stored UL status information to the NW.

According to one embodiment, a field in a DCI indicates a request to report the UL status information. According to one implementation of the embodiment, a field in a DCI indicates the request to report UL status information. In one example, the DCI is a DCI scheduling a PUSCH transmission. According to one implementation of the embodiment, the UE generates in response to the reception of such UL status request, e.g., DCI indicating the request, a new MAC CE which is comprised of the UL status information (as disclosed in the above embodiments) and sends the UL status MAC CE in one example on the PUSCH resources allocated by the DCI request the UL status report. Introducing a procedure to explicitly request UL status information from the UE may be beneficial when using reinforcement learning for the training of an AI/ML-based scheduler rather than using a data collection of UL status information samples for offline training (e.g., supervised learning).

According to one implementation of the embodiment, some timing constraints/processing timing requirements for the reporting of UL status information (UE status MAC CE) are defined. According to one example, some predefined minimum time between the reception of a DCI requesting a UL status report and the corresponding PUSCH resources used for the transmission of the UL Status MAC CE is defined. Essentially, the NW should not allocate UL resources for the transmission of a UL status MAC CE, which are less than the predefined minimum time from the DCI requesting a UL status.

According to one implementation of the embodiment, a scheduling request (SR) configuration is linked to the new UL status MAC CE. For cases when the UE has a pending trigger for UL status reporting, e.g., based on a DCI requesting a UL status report, but no available UL-SCH resources, the UE shall, according to one example, trigger a SR.

In one example, RRC configures some latency requirements for the UL status reporting procedure. In one exemplary implementation, a timer is maintained by the UE to follow the latency requirements configured by the NW (gNB). When a UL status information reporting has been triggered, e.g., in response to receiving a DCI requesting an UL status report, and the timer is not running, the UE starts the timer. In response to the expiry of the timer, the UE cancels the triggered UL status report. Essentially, the UE transmits the triggered UL status information during the time period while the timer is running, e.g., the latency requirements configured by the NW.

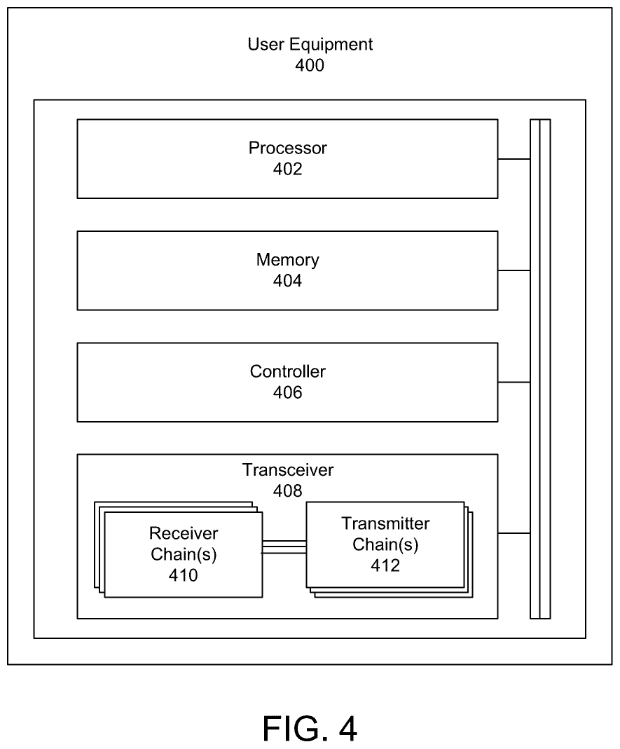

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receiving the signal over the air or wireless medium. The receiver chain 410 may include at least one amplifier (e.g., a low-noise amplifier (LNA)) configured to amplify the received signal. The receiver chain 410 may include at least one demodulator configured to demodulate the received signal and obtain the transmitted data by reversing the modulation technique applied during transmission of the signal. The receiver chain 410 may include at least one decoder for decoding and processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

The UE 400 may be configured to or operable to support a means to receive a configuration for capturing uplink status information, the uplink status information comprising buffer status information, delay status information, or a combination thereof, capture the uplink status information according to the configuration, and report the uplink status information to a learning-based scheduler.

In one embodiment, the delay status information indicates a delay associated with data indicated by the buffer status information. In one embodiment, the delay status information comprises a remaining delay associated with a data unit, wherein the remaining delay is determined based on a PDCP timer.

In one embodiment, the buffer status information comprises at least one data volume associated with a LCG, wherein the data volume corresponds to a total amount of data available for transmission for the LCG. In one embodiment, the delay status information comprises a smallest remaining value of a PDCP timer for buffered data units for the LCG.

In one embodiment, the buffered data units have not been transmitted in a MAC CE. In one embodiment, the delay status information comprises a total amount of delay-critical data for the LCG. In one embodiment, the delay status information comprises a total amount of data for the LCG for which a corresponding remaining delay is within a predetermined delay range.

In one embodiment, the uplink status information comprises information associated with data that is added to a logical channel or logical channel group. In one embodiment, the uplink status information comprises data for which a PDCP timer is expired, and the data is available for transmission.

In one embodiment, the uplink status information comprises uplink power information, wherein the uplink power information is power headroom information. In one embodiment, the power headroom information comprises virtual power headroom information. In one embodiment, the uplink status information comprises pathloss information.

In one embodiment, the uplink status information comprises uplink grant information or uplink resource allocation information for previous uplink transmissions. In one embodiment, the uplink grant information or uplink resource allocation information comprises information for received or executed uplink grants or uplink resource allocations since a last report of uplink status information.

In one embodiment, the uplink grant information comprises transport block size information associated with a corresponding uplink grant. In one embodiment, the uplink status information comprises a timestamp indicating when an uplink transmission is performed or when an uplink grant is received.

In one embodiment, the uplink status information comprises a timestamp indicating when the uplink status information is generated. In one embodiment, the uplink status information comprises QoE information. In one embodiment, the at least one processor is configured cause the UE to store the captured uplink status information.

In one embodiment, the UE 400 may be configured to or operable to support a means to store the captured uplink status information based on a received RRC configuration. In one embodiment, the RRC configuration indicates for which logical channel or logical channel group the uplink status information should be stored.

In one embodiment, the UE 400 may be configured to or operable to support a means to cease storing the uplink status information in response to a change in a radio bearer configuration. In one embodiment, the stored uplink status information comprises one or more layer 2 configuration parameters associated with the UE while storing the uplink status information.

In one embodiment, the stored uplink status information comprises logical channel restriction configuration information. In one embodiment, the stored uplink status information comprises an indication of whether PSI-based discarding was enabled while storing the uplink status information.

In one embodiment, the UE 400 may be configured to or operable to support a means to report the uplink status information using UE assistance information reporting. In one embodiment, the UE 400 may be configured to or operable to support a means to report the uplink status information in response to receiving a request to report the uplink status information.

In one embodiment, the request is received as a field in a DCI for scheduling an uplink transmission. In one embodiment, the UE 400 may be configured to or operable to support a means to create a MAC CE comprising the uplink status information and transmit the MAC CE on an uplink resource allocated by the DCI.

In one embodiment, the UE 400 may be configured to or operable to support a means to start a timer in response to the to receiving a request to report the uplink status information. In one embodiment, the UE 400 may be configured to or operable to support a means to report the uplink status information according to a predefined timing constraint, a latency requirement, or a combination thereof, while the timer is running.

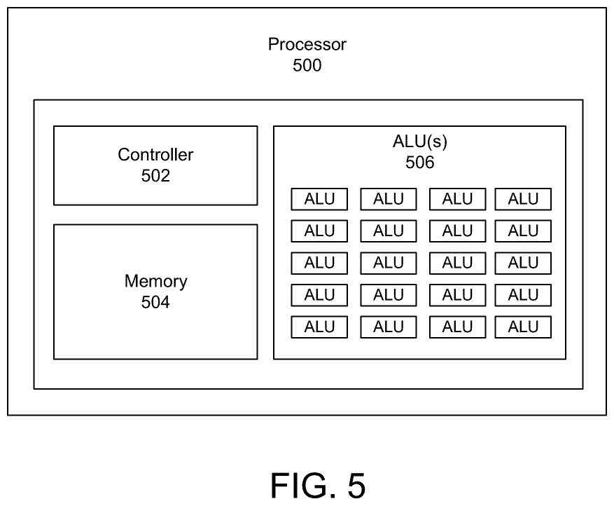

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. In one embodiment, the processor 500 may be configured to or operable to support a means to receive a configuration for capturing uplink status information, the uplink status information comprising buffer status information, delay status information, or a combination thereof, capture the uplink status information according to the configuration, and report the uplink status information to a learning-based scheduler.

In one embodiment, the delay status information indicates a delay associated with data indicated by the buffer status information. In one embodiment, the delay status information comprises a remaining delay associated with a data unit, wherein the remaining delay is determined based on a PDCP timer.

In one embodiment, the buffer status information comprises at least one data volume associated with a LCG, wherein the data volume corresponds to a total amount of data available for transmission for the LCG. In one embodiment, the delay status information comprises a smallest remaining value of a PDCP timer for buffered data units for the LCG.

In one embodiment, the buffered data units have not been transmitted in a MAC CE. In one embodiment, the delay status information comprises a total amount of delay-critical data for the LCG. In one embodiment, the delay status information comprises a total amount of data for the LCG for which a corresponding remaining delay is within a predetermined delay range.

In one embodiment, the uplink status information comprises information associated with data that is added to a logical channel or logical channel group. In one embodiment, the uplink status information comprises data for which a PDCP timer is expired, and the data is available for transmission.

In one embodiment, the uplink status information comprises uplink power information, wherein the uplink power information is power headroom information. In one embodiment, the power headroom information comprises virtual power headroom information. In one embodiment, the uplink status information comprises pathloss information.

In one embodiment, the uplink status information comprises uplink grant information or uplink resource allocation information for previous uplink transmissions. In one embodiment, the uplink grant information or uplink resource allocation information comprises information for received or executed uplink grants or uplink resource allocations since a last report of uplink status information.

In one embodiment, the uplink grant information comprises transport block size information associated with a corresponding uplink grant. In one embodiment, the uplink status information comprises a timestamp indicating when an uplink transmission is performed or when an uplink grant is received.

In one embodiment, the uplink status information comprises a timestamp indicating when the uplink status information is generated. In one embodiment, the uplink status information comprises QoE information. In one embodiment, the at least one processor is configured cause the UE to store the captured uplink status information.

In one embodiment, the processor 500 may be configured to or operable to support a means to store the captured uplink status information based on a received RRC configuration. In one embodiment, the RRC configuration indicates for which logical channel or logical channel group the uplink status information should be stored.

In one embodiment, the processor 500 may be configured to or operable to support a means to cease storing the uplink status information in response to a change in a radio bearer configuration. In one embodiment, the stored uplink status information comprises one or more layer 2 configuration parameters associated with the UE while storing the uplink status information.

In one embodiment, the stored uplink status information comprises logical channel restriction configuration information. In one embodiment, the stored uplink status information comprises an indication of whether PSI-based discarding was enabled while storing the uplink status information.

In one embodiment, the processor 500 may be configured to or operable to support a means to report the uplink status information using UE assistance information reporting. In one embodiment, the processor 500 may be configured to or operable to support a means to report the uplink status information in response to receiving a request to report the uplink status information.

In one embodiment, the request is received as a field in a DCI for scheduling an uplink transmission. In one embodiment, the processor 500 may be configured to or operable to support a means to create a MAC CE comprising the uplink status information and transmit the MAC CE on an uplink resource allocated by the DCI.

In one embodiment, the processor 500 may be configured to or operable to support a means to start a timer in response to the to receiving a request to report the uplink status information. In one embodiment, the processor 500 may be configured to or operable to support a means to report the uplink status information according to a predefined timing constraint, a latency requirement, or a combination thereof, while the timer is running.

In one embodiment, the processor 500 may be configured to or operable to support a means to transmit a configuration for capturing uplink status information at a UE, the uplink status information comprising buffer status information, delay status information, or a combination thereof. The processor 500 may be configured to or operable to support a means to receive the uplink status information from the UE and train a learning-based scheduler based on the uplink status information.

In one embodiment, the processor 500 may be configured to or operable to support a means to transmit a request for the uplink status information.

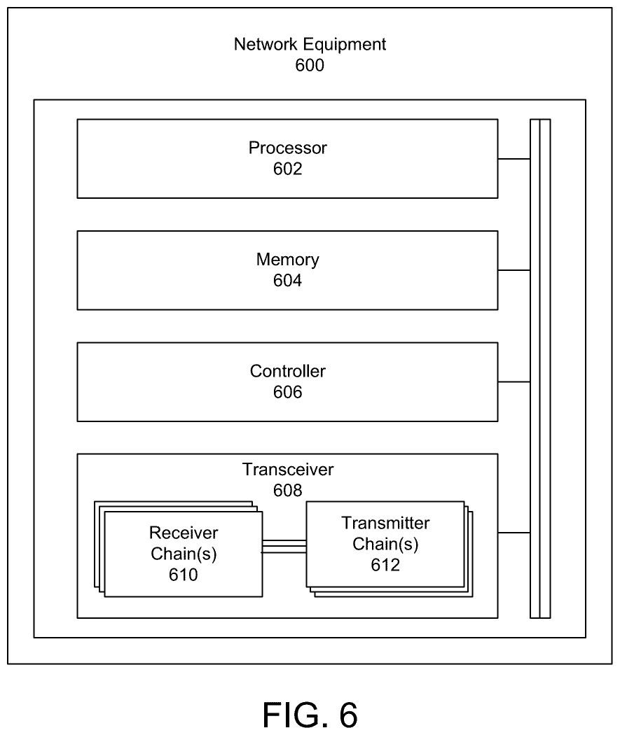

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The NE 600 may be configured to support a means to determine a NES mode for the NE, the NES mode comprising a DU-specific mode or an RU-specific mode of a distributed architecture, determine an NES class and an NES configuration for a traffic flow associated with the NE based on the NES mode, the NES class associated with a QoS class for the traffic flow, map the traffic flow to a DU, an RU, or a combination thereof based on the NES class associated with the traffic flow, and transmit the NES configuration to the DU, the RU, or the combination thereof mapped to the traffic flow.

In one embodiment, the NE 600 may be configured to support a means to transmit a configuration for capturing uplink status information at a UE, the uplink status information comprising buffer status information, delay status information, or a combination thereof. The NE 600 may be configured to support a means to receive the uplink status information from the UE and train a learning-based scheduler based on the uplink status information.

In one embodiment, the NE 600 may be configured to support a means to transmit a request for the uplink status information.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 causes the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

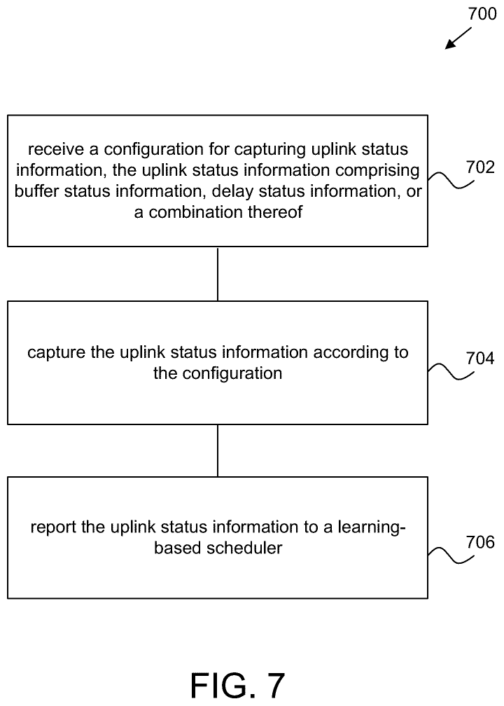

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may receive a configuration for capturing uplink status information, the uplink status information comprising buffer status information, delay status information, or a combination thereof. The operations of 702 may be performed in accordance with examples as described herein. In some implementations, aspects of the operations of 702 may be performed by the UE as described with reference to FIG. 4.

At 704, the method may capture the uplink status information according to the configuration. The operations of 704 may be performed in accordance with examples as described herein. In some implementations, aspects of the operations of 704 may be performed by the UE as described with reference to FIG. 4.

At 706, the method may report the uplink status information to a learning-based scheduler. The operations of 706 may be performed in accordance with examples as described herein. In some implementations, aspects of the operations of 706 may be performed by the UE as described with reference to FIG. 4.

It should be noted that the method described herein describes a possible implementation, and that the operations and the steps may be rearranged or otherwise modified and that other implementations are possible.

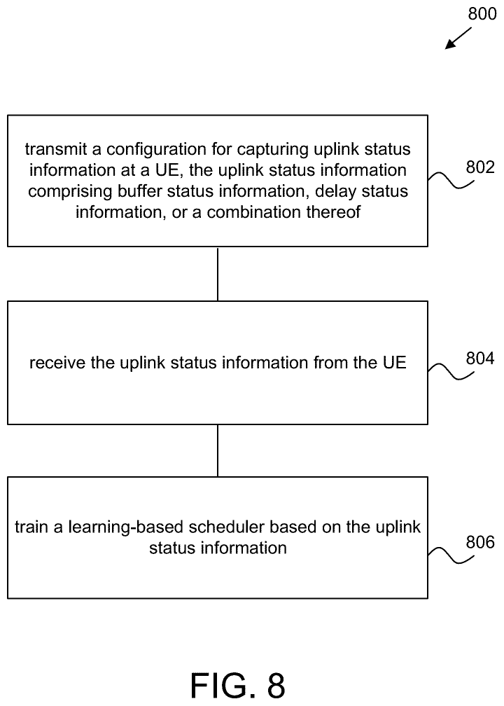

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may transmit a configuration for capturing uplink status information at a UE, the uplink status information comprising buffer status information, delay status information, or a combination thereof. The operations of 802 may be performed in accordance with examples as described herein. In some implementations, aspects of the operations of 802 may be performed by the NE as described with reference to FIG. 6.

At 804, the method may receive the uplink status information from the UE. The operations of 804 may be performed in accordance with examples as described herein. In some implementations, aspects of the operations of 804 may be performed by the NE as described with reference to FIG. 6.

At 806, the method may train a learning-based scheduler based on the uplink status information. The operations of 806 may be performed in accordance with examples as described herein. In some implementations, aspects of the operations of 806 may be performed by the NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for capturing uplink status information, the uplink status information comprising buffer status information, delay status information, or a combination thereof;
capture the uplink status information according to the configuration; and
report the uplink status information to a learning-based scheduler.

2. The UE of claim 1, wherein:
the delay status information indicates a delay associated with data indicated by the buffer status information.

3. The UE of claim 1, wherein:
the delay status information comprises a remaining delay associated with a data unit, wherein the remaining delay is determined based on a packet data convergence protocol (PDCP) timer.

4. The UE of claim 1, wherein:
the buffer status information comprises at least one data volume associated with a logical channel group (LCG), wherein the data volume corresponds to a total amount of data available for transmission for the LCG.

5. The UE of claim 4 wherein:
the delay status information comprises a total amount of delay-critical data for the LCG.

6. The UE of claim 4, wherein:
the delay status information comprises a total amount of data for the LCG for which a corresponding remaining delay is within a predetermined delay range.

7. The UE of claim 1, wherein:
the uplink status information comprises uplink power information, wherein the uplink power information is power headroom information.

8. The UE of claim 7, wherein:
the power headroom information comprises virtual power headroom information.

9. The UE of claim 1, wherein:
the uplink status information comprises uplink grant information or uplink resource allocation information for previous uplink transmissions.

10. The UE of claim 9, wherein:
the uplink grant information or uplink resource allocation information comprises information for received or executed uplink grants or uplink resource allocations since a last report of uplink status information.

11. The UE of claim 9, wherein:
the uplink grant information comprises transport block size information associated with a corresponding uplink grant.

12. The UE of claim 1, wherein:
the at least one processor is configured cause the UE to store the captured uplink status information based on a received radio resource control (RRC) configuration.

13. The UE of claim 12, wherein:
the RRC configuration indicates for which logical channel or logical channel group the uplink status information should be stored.

14. The UE of claim 1, wherein:
the at least one processor is configured cause the UE to report the uplink status information in response to receiving a request to report the uplink status information.

15. The UE of claim 14, wherein:
the request is received as a field in a downlink control information (DCI) for scheduling an uplink transmission.

16. The UE of claim 15, wherein:
the at least one processor is configured cause the UE to create a medium access control (MAC) control element (CE) comprising the uplink status information and transmit the MAC CE on an uplink resource allocated by the DCI.

17. A processor for wireless communication, comprising:
at least one controller coupled with at least one memory and configured to cause the processor to:
receive a configuration for capturing uplink status information, the uplink status information comprising buffer status information, delay status information, or a combination thereof;
capture the uplink status information according to the configuration; and
report the uplink status information to a learning-based scheduler.

18. A method performed by a user equipment (UE), comprising:
receiving a configuration for capturing uplink status information, the uplink status information comprising buffer status information, delay status information, or a combination thereof;
capturing the uplink status information according to the configuration; and
reporting the uplink status information to a learning-based scheduler.

19. A network entity for wireless communication, comprising:
at least one memory; and
at least one processor coupled with the at least one memory and configured to cause the network entity to:
transmit a configuration for capturing uplink status information at a user equipment (UE), the uplink status information comprising buffer status information, delay status information, or a combination thereof;
receive the uplink status information from the UE; and
train a learning-based scheduler based on the uplink status information.

20. The network entity of claim 19, wherein:
the at least one processor is configured cause the network entity to transmit a request for the uplink status information.
